(19) United States
(12) Patent Application Publication
(10) Pub. No.: US 2013/0234920 A1
(43) Pub. Date: Sep. 12, 2013

(54) LIQUID CRYSTAL DISPLAY DEVICE

(71) Applicant: PANASONIC LIQUID CRYSTAL DISPLAY CO., LTD., Himeji-shi (JP)

(72) Inventors: Ryutaro OKE, Osaka (JP); Yoshihisa OOISHI, Osaka (JP)

(73) Assignee: PANASONIC LIQUID CRYSTAL DISPLAY CO., LTD., Himeji-shi (JP)

(21) Appl. No.: 13/785,918

(22) Filed: Mar. 5, 2013

(30) Foreign Application Priority Data
Mar. 8, 2012 (JP) 2012-051183

(51) Int. Cl. G09G 3/36

(52) U.S. Cl. CPC G09G 3/3655
USPC 345/94

(57) ABSTRACT

Provided is a liquid crystal display device capable of preventing a type of screen burn-in phenomenon caused by fluctuations in DC component of a liquid crystal drive voltage, which occurs when the refresh rate is switched. A control device can perform quadruple speed drive and double speed drive of a liquid crystal panel in an inversion drive method. A common electrode is supplied with a common voltage set in advance based on a midpoint potential in inversion drive of voltages set for a pixel electrode in the quadruple speed drive. In both of the quadruple speed drive and the double speed drive switched from the quadruple speed drive, a width of a scanning pulse (Pₖ) of a gate voltage (VGₖ) is set to a width of 1H in the quadruple speed drive.

### CROSS-REFERENCE TO RELATED APPLICATION

The present application claims priority from Japanese application JP2012-051183 filed on Mar. 8, 2012, the content of which is hereby incorporated by reference into this application.

### BACKGROUND OF THE INVENTION

1. Field of the Invention

The present invention relates to a liquid crystal display device, and more particularly, to a technology of switching a refresh rate during display operation.

2. Description of the Related Art

Liquid crystal display devices are used in products such as a thin-screen television, a personal computer, a tablet terminal, and a smartphone. Many display devices including the liquid crystal display device periodically refresh a display image. In television broadcasting and the like, a standard refresh rate is, for example, 60 Hz. In recent years, for improvement in moving image quality and 3D display, there is a demand for image display at a higher refresh rate, and there are liquid crystal display devices that can drive at 120 Hz (double speed drive) and 240 Hz (quadruple speed drive).

Liquid crystal display devices capable of performing double speed drive or quadruple speed drive are generally constructed so that its drive is switchable to that at a lower rate, to thereby provide a function of setting the drive speed to a user. Further, there are also liquid crystal display devices having a function of automatically switching the drive speed. For example, when the spatial frequency of an image increases, heat generation of a drive circuit and the like increases. In view of this, for example, when temperature increase or input of a video signal that causes increase of heat generation is detected during quadruple speed drive, the drive is switched to double speed drive.

The liquid crystal display device controls liquid crystal alignment through application of a voltage between a pixel electrode and a common electrode. In this case, a DC voltage to be applied between the pixel electrode and the common electrode easily causes such a phenomenon called screen burn-in that a still image displayed in the past appears as a residual image. This is caused because, through application of the DC voltage, ionic impurities in liquid crystal accumulate in the vicinity of the electrode. In order to prevent the screen burn-in, basically in synchronization with the refresh operation, the liquid crystal display device performs AC drive (inversion drive) in which a voltage to be applied to the pixel electrode is switched alternately between a higher (positive) voltage and a lower (negative) voltage.

In the AC drive, a common potential (common voltage) V_{com} that is a constant voltage is applied to the common electrode. From the purpose of the AC drive of preventing the screen burn-in, the common potential V_{com} is required to be set so that a DC component is not generated in the AC drive. For example, when the entire screen has the same pixel value, V_{com} can be set as a midpoint potential between a potential VP_{H} set for the pixel electrode based on the positive voltage corresponding to the pixel value and a potential VP_{L} set for the pixel electrode based on the negative voltage corresponding to the pixel value. In the actual case, the midpoint potential may vary, although subtle, in accordance with the pixel value, and hence V_{com} is adjusted so that, for example, the DC component in the entire screen becomes as small as possible based on the standard image and the like.

In this case, the brightness of the pixel changes in accordance with an effective value of the voltage to be applied between the pixel electrode and the common electrode. The voltage effective value when certain VP_{H} and certain VP_{L} are written to the pixel electrode in the AC drive depends on the common potential. When the common potential is the midpoint potential between VP_{H} and VP_{L}, in other words, when a DC component of a liquid crystal drive voltage is 0, the voltage effective value is the minimum, and as the common potential is offset from the midpoint potential and the absolute value of the DC component increases, the voltage effective value increases. FIG. 7 is a graph showing a characteristic curve representing dependency of brightness with respect to a DC component V_{DC} of the liquid crystal drive voltage in a liquid crystal panel which is normally black such as an in-plane switching (IPS) type. The horizontal axis represents the voltage V_{DC} of the DC component, and the vertical axis represents the brightness. In the normally black liquid crystal panel, the characteristic curve is a concave upward curve, and takes a minimum value when the DC component V_{DC} is 0. On both sides of the minimum value, there are ranges in which the slope (rate of change of brightness with respect to DC component V_{DC}) increases along with the increase of the absolute value of the DC component V_{DC}.

### SUMMARY OF THE INVENTION

FIG. 8 is a schematic timing diagram illustrating writing of the video signal to the pixel electrode in the quadruple speed drive and the double speed drive. A voltage (data voltage VS) based on pixel data Dₖ (k=1 to n) for k-th row is sequentially supplied to a source line (video signal line) for each of horizontal scanning periods (1H). In the AC drive, the polarity of the voltage based on the pixel data is switched for each of vertical scanning periods (1V). Further, a scanning pulse (gate pulse) Pₖ having a width of 1H is sequentially generated for each 1H for a voltage signal VGₖ supplied to a gate line (scanning line) provided correspondingly to each row. When a thin film transistor (TFT) provided in each pixel is applied with the scanning pulse from the gate line in the corresponding row, a channel between the source line and the pixel electrode becomes an ON state, and the pixel electrode is charged. A voltage (pixel voltage) VP of this pixel electrode becomes a potential corresponding to the data voltage VS. FIG. 8 illustrates a voltage of the second row as an example of the pixel voltage VP. When the scanning pulse P₂ is applied to the gate line in the second row, VP increases in a frame in which a positive voltage is applied to the source line. When the scanning pulse falls, a potential change called a feedthrough occurs due to the parasitic capacitance between a gate electrode and a drain, and then the pixel voltage VP_{H} is set. In contrast, VP decreases in a frame in which a negative voltage is applied. When the scanning pulse falls, a feedthrough occurs, and then the pixel voltage VP_{L} is set.

1V and 1H in the quadruple speed drive are ½ of those in the double speed drive, and the width of the scanning pulse is set to be half the width of that in the double speed drive as well. FIG. 9 is a schematic signal waveform diagram illustrating the writing of the video signal to the pixel electrode in one certain row in the quadruple speed drive and the double speed drive, and represents the time variation of the gate voltage VG, the data voltage VS, and the pixel voltage VP. The horizontal axis represents time, and the vertical axis represents voltage.

In the quadruple speed drive represented in the left half of FIG. 9, in the frame of the positive voltage, during a pulse application period of the gate voltage VG, the pixel voltage VP increases from a potential VP_{L4} set in the previous frame toward a data voltage VS_{H}, and after the scanning pulse application period, the potential VP_{H4} at the falling of the pulse is maintained. On the other hand, in the frame of the negative voltage, during the scanning pulse application period, the pixel voltage VP falls from the potential VP_{H4} set in the previous frame toward a data voltage VS_{L}, and after the scanning pulse application period, the potential VP_{L4} at the falling of the pulse is maintained.

Also in the double speed drive represented in the right half of FIG. 9, basically similarly to the case of the quadruple speed drive, in the frame of the positive voltage, the pixel voltage is set to VP_{H2}, and in the frame of the negative voltage, the pixel voltage is set to VP_{L2}. Note that, a difference may be generated between the quadruple speed drive and the double speed drive in the pixel voltage set with respect to the same pixel data due to the difference of the period for charging the pixel electrode. In particular, for example, when the TFT has an n-channel, the difference becomes larger in the frame of the positive voltage than in the frame of the negative voltage. In other words, a difference between VP_{H4} and VP_{H2}, denoted by |VP_{H4}−VP_{H2}|, becomes larger than a difference between VP_{L4} and VP_{L2}, denoted by |VP_{L4}−VP_{L2}|. This is because a gate-source voltage V_{GS} of the TFT becomes smaller to decrease the channel current when the positive voltage is applied than when the negative voltage is applied. Thus, the difference in width of the scanning pulse exerts a significant influence. This case is represented in the state of FIG. 9 that, during the scanning pulse application period, VP_{L4} and VP_{L2} promptly decrease to reach VS_{L} regardless of the difference of the scanning pulse width, while in the quadruple speed drive having a shorter scanning pulse, VP_{H4} does not reach VS_{H}, and in the double speed drive having a longer scanning pulse, VP_{H2} reaches VS_{H}.

The asymmetry property of writing of the pixel voltage between when the positive voltage is applied and when the negative voltage is applied generates a difference between a midpoint potential V_{M4} of the pixel voltages in the quadruple speed drive and a midpoint potential V_{M2} of the pixel voltages in the double speed drive. Therefore, when the common potential V_{com} is set suitably for the quadruple speed drive, the common potential V_{com} is not suitable for the double speed drive, and a voltage V_{offset} is generated in the DC component V_{DC} of the liquid crystal drive voltage in the double speed drive.

In this case, even when the common potential V_{com} is set suitably for the quadruple speed drive, the midpoint potential V_{M4} does not match with V_{com} in all of the pixel data in the quadruple speed drive. In each pixel, a DC voltage corresponding to a difference between the midpoint potential V_{M4} and V_{com} may be applied to the liquid crystal. Thus, ionic impurities may accumulate in the vicinity of the electrode, which may cause screen burn-in. However, through setting of V_{com} to an optimum value, the difference between the midpoint potential V_{M4} and V_{com} becomes smaller, and hence a DC voltage φ which causes accumulation of the ionic impurities becomes smaller as well. That is, in the quadruple speed drive, even when the same image is displayed for a long period of time, the DC voltage V_{DC} of each of the pixels is in the vicinity of 0, and hence as understood from the characteristic curve shown in FIG. 7, the brightness change due to the DC voltage φ is small, and the screen burn-in is inconspicuous.

On the other hand, when the quadruple speed drive is switched to the double speed drive from this state, the DC voltage V_{DC} of each of the pixels becomes a value obtained by combining the voltage φ and the voltage V_{offset}. In other words, in the double speed drive, the DC voltage V_{DC} becomes the vicinity of V_{offset} that is offset from 0, and as understood from the characteristic curve shown in FIG. 7, the brightness difference due to the difference of the DC voltage φ becomes larger than in the case of the quadruple speed drive. Therefore, when the quadruple speed drive is switched to the double speed drive, the difference of the pixel data in the image of the quadruple speed drive before the switching appears as brightness difference to the image of the double speed drive, which causes a problem of image quality deterioration.

The case of switching from the quadruple speed drive to the double speed drive has been described here as an example, but the similar problem can generally occur when the refresh rate is switched.

The present invention prevents image quality deterioration in the liquid crystal display device caused by a type of screen burn-in phenomenon as described above, which occurs when the refresh rate is switched.

A liquid crystal display device according to an exemplary embodiment of the present invention includes: a liquid crystal panel of an active matrix drive type, including: a switching element which establishes electrical connection through application of a gate pulse from a scanning line; a pixel electrode to be supplied with a pixel voltage corresponding to a pixel value from a video line via the switching element; and a common electrode for generating, together with the pixel electrode, an electric field for driving liquid crystal; and a drive circuit for driving the liquid crystal panel in an inversion drive method, the drive circuit being capable of switching between a first display operation and a second display operation which have horizontal scanning periods that differ from each other, the drive circuit including: a common electrode drive circuit for applying a common voltage, which is set in advance based on a midpoint potential in inversion drive of voltages set for the pixel electrode in the first display operation, to the common electrode in the first display operation and the second display operation; and a scanning line drive circuit for generating the gate pulse in common for the first display operation and the second display operation.

In the liquid crystal display device according to the exemplary embodiment of the present invention, the drive circuit may be configured to provide a transition period between a period of the first display operation and a period of the second display operation, for changing the horizontal scanning period in a stepwise manner.

In the liquid crystal display device according to a preferred embodiment of the present invention, the second display operation has a refresh rate that is half of a refresh rate of the first display operation, and the scanning line drive circuit is configured to generate the gate pulse having a width corresponding to the horizontal scanning period in the first display operation.

A liquid crystal display device according to another exemplary embodiment of the present invention includes: a liquid crystal panel of an active matrix drive type, including: a switching element which establishes electrical connection through application of a gate pulse from a scanning line; a pixel electrode to be supplied with a pixel voltage corresponding to a pixel value from a video line via the switching element; and a common electrode for generating, together with the pixel electrode, an electric field for driving liquid crystal; and a drive circuit for driving the liquid crystal panel in an inversion drive method, the drive circuit being capable of switching between a first display operation and a second display operation which have horizontal scanning periods that differ from each other, the drive circuit including: a common electrode drive circuit for applying a common voltage, which is set in advance based on a midpoint potential in inversion drive of voltages set for the pixel electrode in the first display operation, to the common electrode in the first display operation and the second display operation; and a scanning line drive circuit for changing a width of the gate pulse proportional to the horizontal scanning period when switching is performed between the first display operation and the second display operation, and setting, in the second display operation, a voltage of the gate pulse to a value determined in advance so that a midpoint potential in the inversion drive of voltages set for the pixel electrode in the second display operation matches with the common voltage.

In the liquid crystal display device according to the another exemplary embodiment of the present invention, the drive circuit may be configured to: provide a transition period between a period of the first display operation and a period of the second display operation, for changing the horizontal scanning period in a stepwise manner; and change the voltage of the gate pulse in the stepwise manner in the transition period.

In the liquid crystal display device according to a preferred embodiment of the present invention, the switching element is an n-type thin film transistor, the second display operation has a refresh rate that is half of a refresh rate in the first display operation, and the scanning line drive circuit is configured to set the voltage of the gate pulse in the second display operation to be lower than a voltage of the gate pulse in the first display operation.

A liquid crystal display device according to still another exemplary embodiment of the present invention includes: a liquid crystal panel of an active matrix drive type, including: a switching element which establishes electrical connection through application of a gate pulse from a scanning line; a pixel electrode to be supplied with a pixel voltage corresponding to a pixel value from a video line via the switching element; and a common electrode for generating, together with the pixel electrode, an electric field for driving liquid crystal; and a drive circuit for driving the liquid crystal panel in an inversion drive method, the drive circuit being capable of switching between a first display operation and a second display operation which have horizontal scanning periods that differ from each other, the drive circuit including: a common electrode drive circuit for applying a common voltage, which is set in advance based on a midpoint potential in inversion drive of voltages set for the pixel electrode in the first display operation, to the common electrode in the first display operation and the second display operation; and a scanning line drive circuit for changing a width of the gate pulse proportional to the horizontal scanning period when switching is performed between the first display operation and the second display operation, and setting, in the second display operation, the pixel voltage with respect to each pixel value to a value obtained by multiplying the pixel voltage in the first display operation with respect to the corresponding pixel value by a factor determined in advance so that a midpoint potential in the inversion drive in the second display operation matches with the common voltage.

In the liquid crystal display device according to the still another exemplary embodiment of the present invention, the drive circuit may be configured to: provide a transition period between a period of the first display operation and a period of the second display operation, for changing the horizontal scanning period in a stepwise manner; and change the factor in the stepwise manner in the transition period.

In the liquid crystal display device according to a preferred embodiment of the present invention, the switching element is an n-type thin film transistor, the second display operation has a refresh rate that is half of a refresh rate in the first display operation, and the scanning line drive circuit is configured to set the factor to be smaller than 1.

### BRIEF DESCRIPTION OF THE DRAWINGS

In the accompanying drawings:

FIG. 1 is a schematic view illustrating a configuration of a liquid crystal display device according to each of embodiments of the present invention;

FIG. 2 is a schematic timing diagram illustrating an operation of switching from quadruple speed drive to double speed drive in a liquid crystal display device according to a first embodiment of the present invention;

FIG. 3 is a schematic signal waveform diagram illustrating writing of a video signal to a pixel electrode in one certain row in the quadruple speed drive and the double speed drive in the first embodiment;

FIG. 4 is a schematic signal waveform diagram illustrating an example of an operation of switching from the quadruple speed drive to the double speed drive while providing a transition period in the first embodiment;

FIG. 5 is a schematic signal waveform diagram illustrating writing of a video signal to a pixel electrode in one certain row in quadruple speed drive and double speed drive in a second embodiment of the present invention;

FIG. 6 is a schematic signal waveform diagram illustrating writing of a video signal to a pixel electrode in one certain row in quadruple speed drive and double speed drive in a third embodiment of the present invention;

FIG. 7 is a graph showing a characteristic curve representing dependency of brightness with respect to a DC component of a liquid crystal drive voltage in a normally black liquid crystal panel;

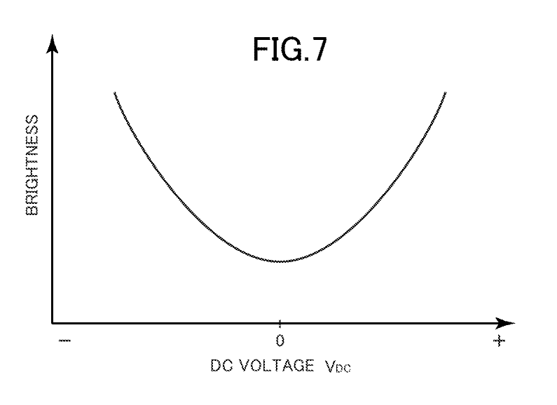

FIG. 8 is a schematic timing diagram illustrating writing of a video signal to a pixel electrode in quadruple speed drive and double speed drive in a conventional case; and

FIG. 9 is a schematic signal waveform diagram illustrating writing of the video signal to the pixel electrode in one certain row in the quadruple speed drive and the double speed drive in the conventional case.

### DETAILED DESCRIPTION OF THE INVENTION

In the following, modes for carrying out the present invention (hereinafter referred to as embodiments) are described with reference to the drawings.

### First Embodiment

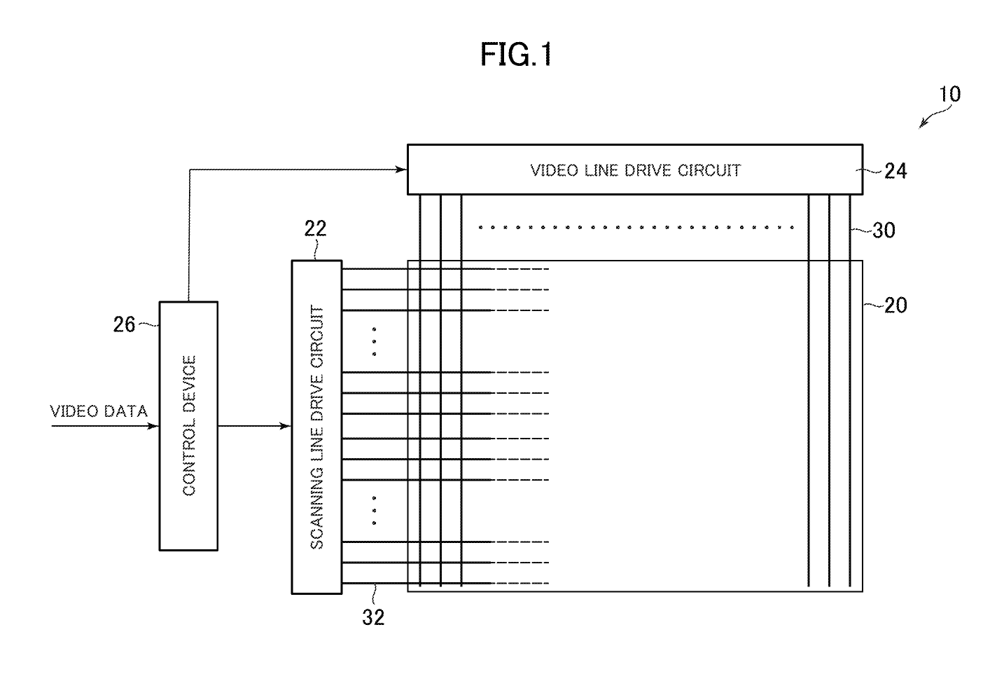

FIG. 1 is a schematic view illustrating a configuration of a liquid crystal display device 10 according to a first embodiment of the present invention. The liquid crystal display device 10 includes a liquid crystal panel 20, a scanning line drive circuit 22, a video line drive circuit 24, a control device 26, a backlight unit (not shown), and a backlight unit drive circuit (not shown).

The liquid crystal display device 10 is, for example, an IPS type and active matrix drive type liquid crystal display device. The liquid crystal panel 20 includes a color filter substrate and a TFT substrate arranged opposed to each other with a gap provided therebetween. The gap is filled with liquid crystal. A polarizing film is bonded on an outer surface of each glass substrate forming each of the color filter substrate and the TFT substrate. The TFT substrate is positioned on a rear surface side of the liquid crystal panel 20, and the backlight unit is arranged behind the TFT substrate. On the other hand, the color filter substrate is arranged on a display surface side of the liquid crystal panel 20.

On a surface of the TFT substrate on the liquid crystal side, there are formed a TFT, a pixel electrode, a common electrode, and wiring for those members. Specifically, the pixel electrodes and the TFTs are arranged in matrix so as to correspond to the pixel arrangement. In each of the pixels, the common electrode made of a transparent electrode material similarly to the pixel electrode is arranged. As the wiring, a plurality of source lines 30, a plurality of gate lines 32, and common electrode wiring are formed. The plurality of source lines 30 and the plurality of gate lines 32 are arranged substantially orthogonal to each other. The gate line 32 is provided for each of the rows of the TFTs (arrangement in the horizontal direction), and is connected in common to gate electrodes of a plurality of TFTs in the corresponding row. The source line 30 is provided for each of columns of the TFTs (arrangement in the vertical direction), and is connected in common to sources of a plurality of TFTs in the corresponding column. Further, a drain of each TFT is connected to the pixel electrode corresponding to the TFT.

In this embodiment, the TFT provided as an active element (switching element) for each pixel has an n-channel, and is turned ON on a row-by-row basis when a scanning pulse that rises in the positive direction is applied thereto from the gate line 32. The pixel electrode is connected to the source line 30 via the TFT in the ON state, and a signal voltage (pixel voltage) corresponding to pixel data is applied from the source line 30 to the pixel electrode. A predetermined common potential V_{com} is applied to the common electrode via the common electrode wiring. An electric field generated in accordance with the voltage between the pixel electrode and the common electrode controls the alignment of the liquid crystal for each of the pixels. Thus, transmittance with respect to incident light from the backlight unit is changed, to thereby form an image on the display surface.

The source lines 30 are connected to the video line drive circuit 24. The gate lines 32 are connected to the scanning line drive circuit 22.

The control device 26 is fed a video signal received by a tuner or an antenna (not shown), or a video signal generated by another device such as a video reproducing device. The control device 26 includes a central processing unit (CPU) and a memory such as a read only memory (ROM) and a random access memory (RAM).

The control device 26 is a drive circuit for performing various image signal processing such as color adjustment with respect to the input video signal, and for generating pixel data representing a grayscale value of each pixel. Further, the control device 26 generates, based on the input video signal, a timing signal for synchronizing the scanning line drive circuit 22, the video line drive circuit 24, and the backlight unit drive circuit, and outputs the generated timing signal to the respective drive circuits. In particular, the control device 26 can switch the refresh rate of the liquid crystal panel 20, and for example, can drive the liquid crystal panel 20 at a double speed or a quadruple speed of 60 Hz that is the standard value. The control device 26 sequentially generates, for each 1H period corresponding to the refresh rate, pixel data for one row from the video signal, and outputs the generated pixel data to the video line drive circuit 24.

The scanning line drive circuit 22 starts, in accordance with the timing signal input from the control device 26, an operation of selecting the gate lines 32 in order and outputting the scanning pulse to the selected gate line 32.

The video line drive circuit 24 receives, in synchronization with the selection of the gate line 32 by the scanning line drive circuit 22, the pixel data of the selected row from the control device 26, and generates a data voltage VS corresponding to each of the pixel data of the corresponding row. The generated data voltage VS is output to the source line 30, and with this, a pixel voltage VP is set to each of the pixel electrode corresponding to the selected gate line 32. By the way, this operation corresponds to horizontal scanning in raster graphics, in which a row is selected for each of horizontal scanning periods (1H) in an effective scanning period in a vertical scanning period (1V), and pixel voltages are written to the corresponding row. In this case, 1V and 1H are each switched in accordance with the scanning speed, and for example, 1V and 1H in the quadruple speed drive are set to half of those in the double speed drive. The potential of the pixel electrode at a time point when the TFT is turned OFF in the writing operation of each row is basically held until writing to the corresponding row is started in the next frame, and during this period, each pixel in the corresponding row is controlled to have a transmittance corresponding to the potential. The liquid crystal display device 10 is a frame inversion type liquid crystal display device, and the video line drive circuit 24 alternately generates a positive voltage VS_{H} and a negative voltage VS_{L} as the data voltage VS for each frame to AC-drive the liquid crystal panel 20.

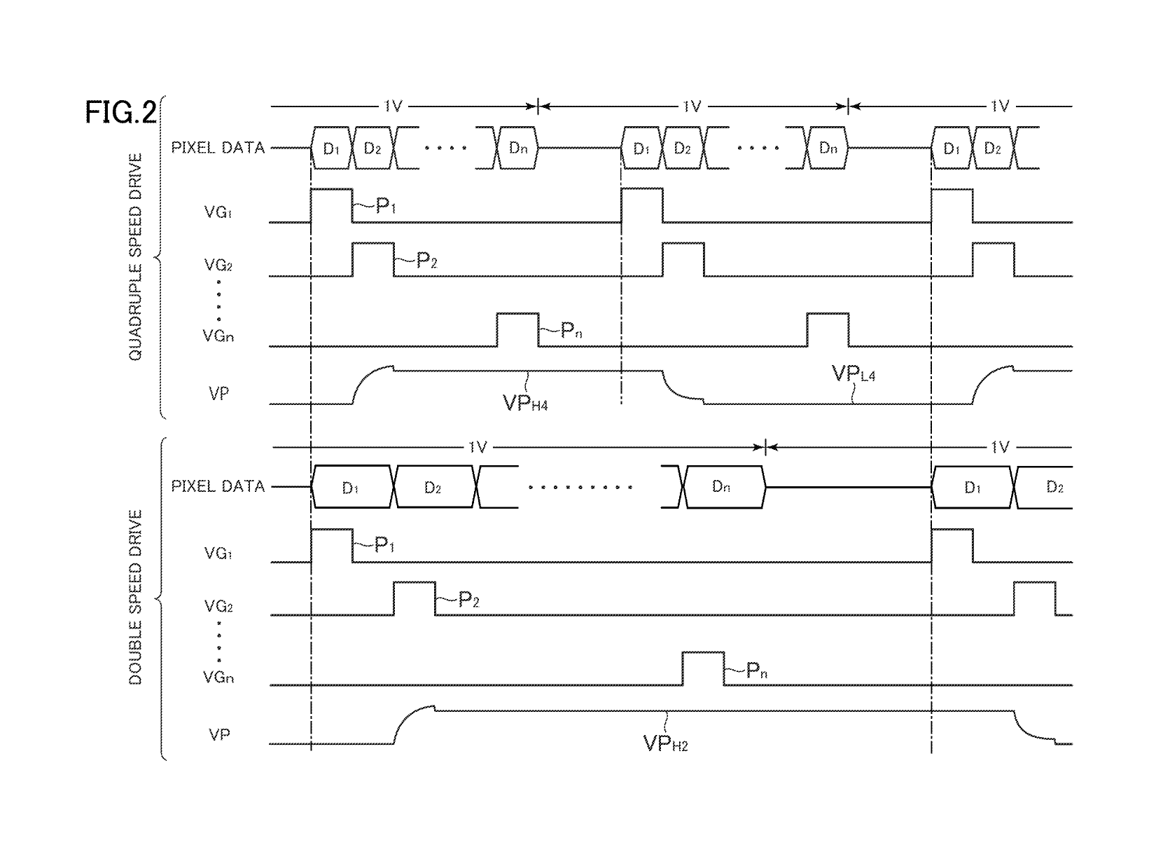

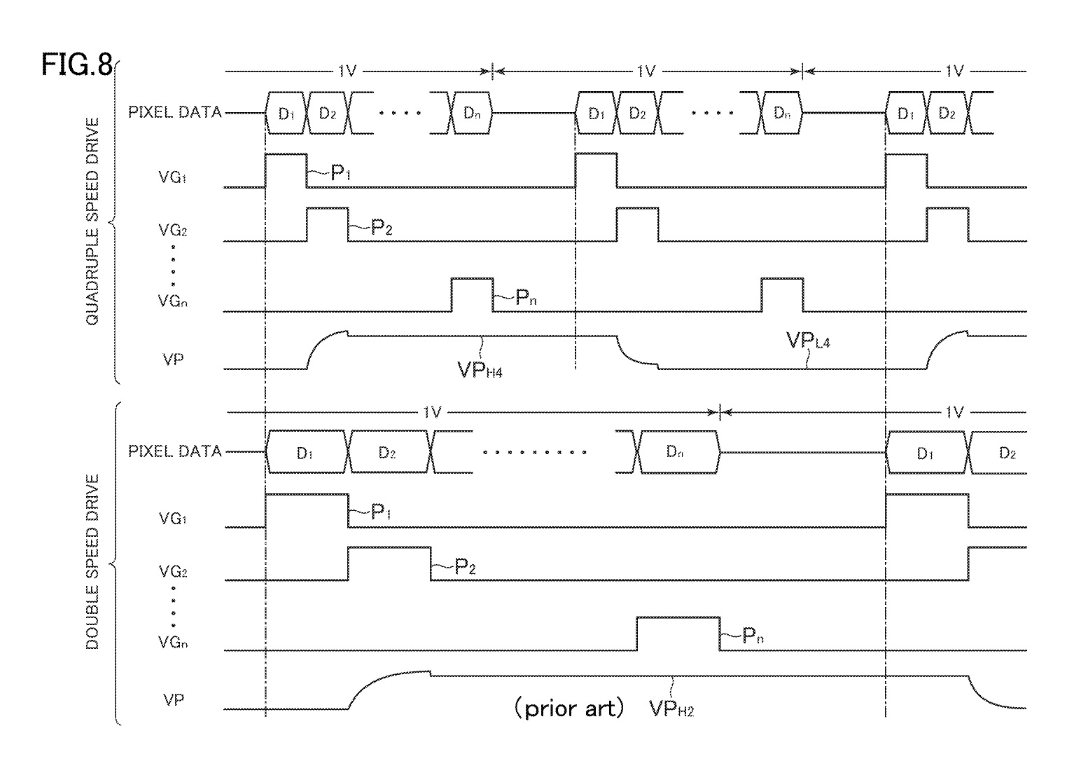

FIG. 2 is a schematic timing diagram illustrating an operation of switching to the double speed drive in the middle of the quadruple speed drive in the liquid crystal display device 10 of this embodiment, and represents a timing of various signals relating to the writing of the video signal to the pixel electrode in the quadruple speed drive and the double speed drive during the operation. The quadruple speed drive in this embodiment is similar to the quadruple speed drive described with reference to FIG. 8, and the difference between the operation of the liquid crystal display device 10 of this embodiment illustrated in FIG. 2 and the operation illustrated in FIG. 8 resides in the double speed drive. The difference resides in the point that, in the operation of FIG. 8, the width of the scanning pulse in the double speed drive is 1H in the double speed drive, while in this embodiment, the width of the scanning pulse in the double speed drive is the same as the width of the scanning pulse in the quadruple speed drive (that is, 1H in the quadruple speed drive). That is, the width of the scanning pulse in the double speed drive is set to be half of the horizontal scanning period (1H) in the double speed drive.

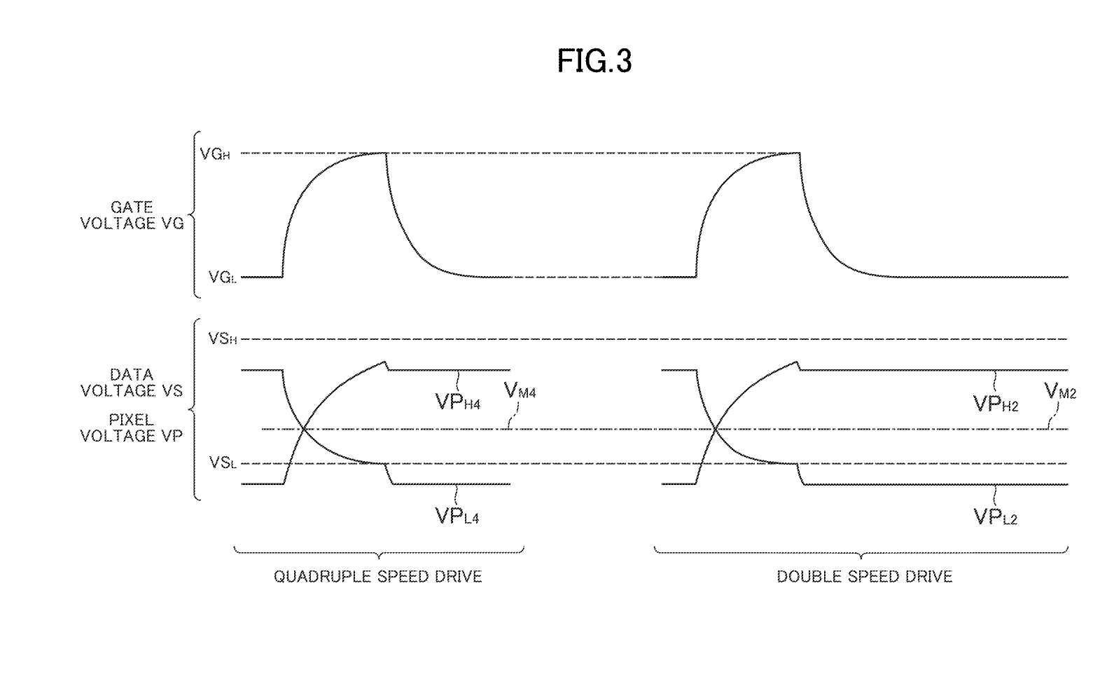

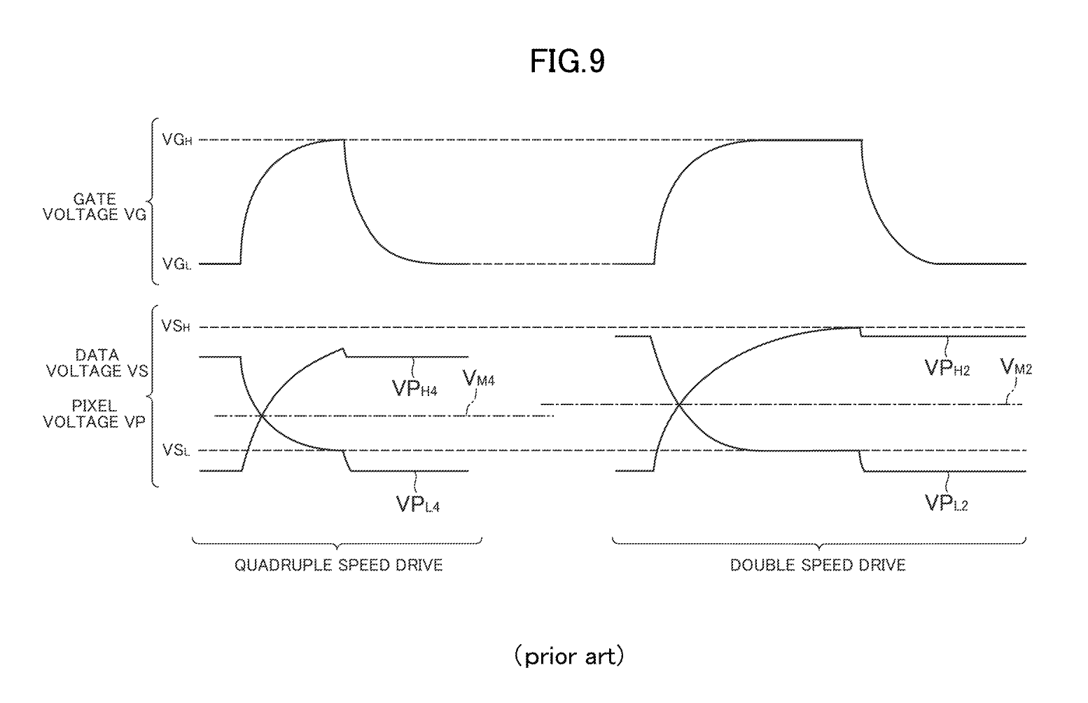

FIG. 3 is a schematic signal waveform diagram illustrating writing of the video signal to the pixel electrode in one certain row in the quadruple speed drive and the double speed drive, and represents the time variation of a gate voltage VG, the data voltage VS, and the pixel voltage VP. The horizontal axis represents time, and the vertical axis represents voltage. The signal waveforms in the quadruple speed drive represented in the left half of FIG. 3 are the same as those in the conventional quadruple speed drive represented in the left half of FIG. 9.

On the other hand, in the double speed drive represented in the right half of FIG. 3, as described above, the pulse application period for the gate voltage VG is set to be the same as in the quadruple speed drive. As a result, a pixel voltage VP_{H2} set for a certain data voltage VS_{H} in the frame of the positive voltage, and a pixel voltage VP_{L2} set for a certain data voltage VS_{L} in the frame of the negative voltage are equal to the pixel voltages VP_{H4} and VP_{L4} set for the data voltages VS_{H} and VS_{L} in the quadruple speed drive, respectively. Therefore, a midpoint potential V_{M2} of the pixel voltages in the double speed drive also becomes equal to a midpoint potential V_{M4} of the pixel voltages in the quadruple speed drive. Therefore, when the common potential V_{com} is set suitably for the quadruple speed drive, the common potential V_{com} becomes suitable also for the double speed drive, and when the quadruple speed drive is switched to the double speed drive, no difference is basically generated in a DC component V_{DC} of a liquid crystal drive voltage.

For example, when the same image is displayed for a long period of time in the quadruple speed drive, as already described above, even if the common potential V_{com} is optimized, a small DC voltage φ that differs depending on the pixel data is generated in each of the pixels. When switching to the double speed drive is performed in this state, in a conventional case, a DC voltage V_{offset} caused by the difference between the midpoint potentials V_{M4} and V_{M2} is superimposed on the DC voltage φ, which causes a problem in that the difference of the DC voltage in each of the pixels becomes apparent as brightness difference. However, in this embodiment, no V_{offset} is generated in switching between the quadruple speed drive and the double speed drive, and the double speed drive can be operated at the DC voltage V_{DC} in the vicinity of 0, at which brightness difference is less caused, similarly to the quadruple speed drive. Therefore, when switching to the double speed drive is performed, the brightness difference due to the difference of the DC voltage of each of the pixels, which is generated in the quadruple speed drive, is inconspicuous.

Further, in the liquid crystal display device 10, there may be provided a transition period between a period of the quadruple speed drive and a period of the double speed drive, for changing the horizontal scanning period in a stepwise manner, to thereby perform the switching of the refresh rate gradually. With this configuration, it is possible to eliminate a sense of discomfort in vision due to the discontinuity of brightness, which may be caused by the difference of the refresh rate.

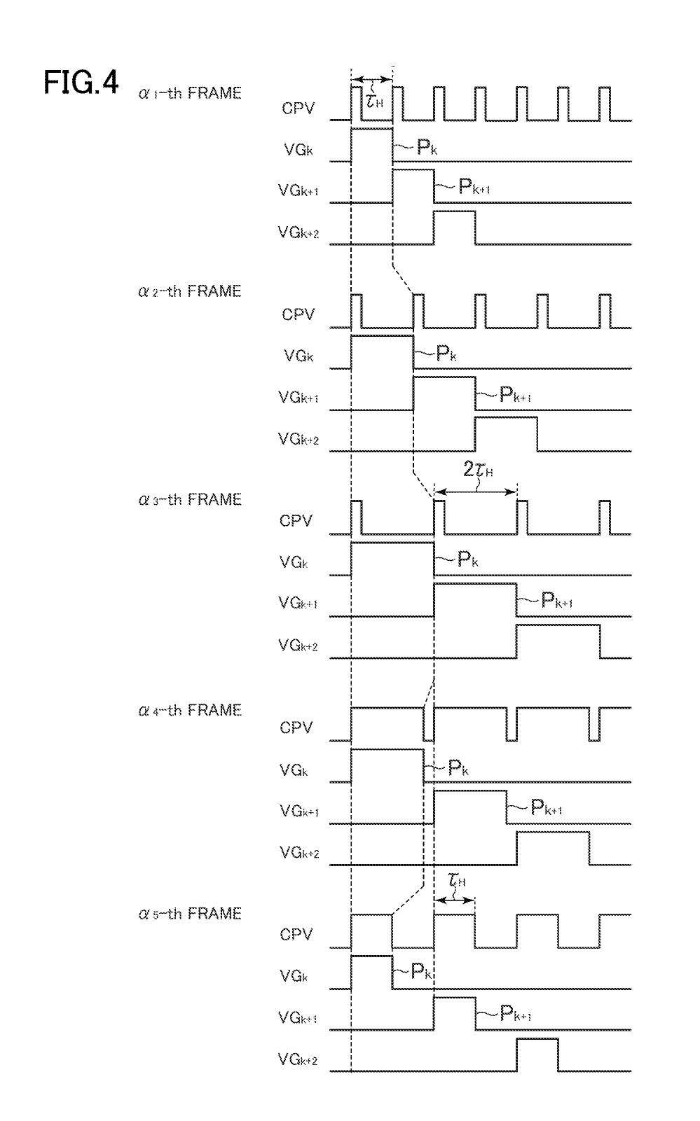

In the transition period, basically, it is preferred that the horizontal scanning period be changed in a stepwise manner for each of the frames of the image to be displayed, while the width of the scanning pulse be maintained to 1H in the quadruple speed drive. On the other hand, the transition period can be set to be a short period, and hence even when a residual image appears due to the screen burn-in for the short period, the residual image is not much conspicuous. Therefore, the transition period may allow generation of a period in which the width of the scanning pulse is not maintained to 1H in the quadruple speed drive, to thereby simplify and reduce the cost of the circuit for switching from the quadruple speed drive to the double speed drive. FIG. 4 is a schematic signal waveform diagram illustrating an operation of switching the refresh rate in an example of a configuration in which the width of the scanning pulse changes in the transition period, and illustrates waveforms of a clock pulse CPV and gate voltages VGₖ to VGₖ₊₂ of k-th to (k+2)th rows of each of α₁-th to α₅-th frames from the quadruple speed drive to the double speed drive. The clock pulse CPV is a clock signal having a 1H period. The control device 26 counts a time τ_{H} corresponding to the period 1H based on a dot clock signal (period τ_{D}) to generate the clock pulse CPV.

In the α₁-th frame, the quadruple speed drive is performed, and the scanning line drive circuit 22 causes the scanning pulse Pₖ to rise at the time of rising of the clock pulse CPV, and causes the scanning pulse Pₖ to fall and the scanning pulse Pₖ₊₁ to rise at the time of the next CPV rising after the elapse of time τ_{H}. With this, in the quadruple speed drive, a scanning pulse having the width τ_{H} is sequentially generated for the gate line 32 of each row.

The α₂-th to α₄-th frames belong to the transition period from the quadruple speed drive to the double speed drive. The control device 26 changes the clock number of the dot clock for counting 1H so that 1H is extended up to, for example, 2τ_{H} (from α₁-th to α₃-th frames). The control device 26 switches, in the α₄-th frame following the α₃-th frame, for example, the circuit for generating the clock pulse CPV, to thereby generate a pulse having a width of 2τ_{H}−τ_{D} as the clock pulse CPV at a period of 2τ_{H}. Further, in synchronization therewith, the scanning line drive circuit 22 switches the operation so that the scanning pulse Pₖ rises at the time of rising of the clock pulse CPV and the scanning pulse Pₖ falls at the time of the falling of CPV. Subsequently, the control device 26 changes the clock number of the dot clock for counting the pulse width of CPV to reduce the pulse width to τ_{H} (from α₄-th to α₅-th frames).

With this, there is generated the gate voltage signal VG of the double speed drive in this embodiment in which the scanning pulse having a width τ_{H} is sequentially output for the gate line 32 of each row at the period of 2τ_{H} (α₅-th frame).

### Second Embodiment

A schematic configuration of a liquid crystal display device according to a second embodiment of the present invention is basically the same as the liquid crystal display device 10 of the above-mentioned embodiment illustrated in FIG. 1. In the following description, components similar to those of the first embodiment are denoted by the same reference symbols for simple description. This embodiment differs from the first embodiment in the method of realizing prevention of image quality deterioration during switching of the refresh rate. In the following, similarly to the first embodiment, description is made of the method in the case of switching from the quadruple speed drive to the double speed drive.

In the first embodiment, the width of the scanning pulse in the double speed drive is set the same as the width of the scanning pulse in the quadruple speed drive. However, in the second embodiment (and the third embodiment described later), similarly to the conventional case, the width of the scanning pulse changes proportional to the horizontal scanning period. In other words, the width of the scanning pulse in the double speed drive is 1H in the double speed drive as in the case of the conventional drive method illustrated in FIG. 8.

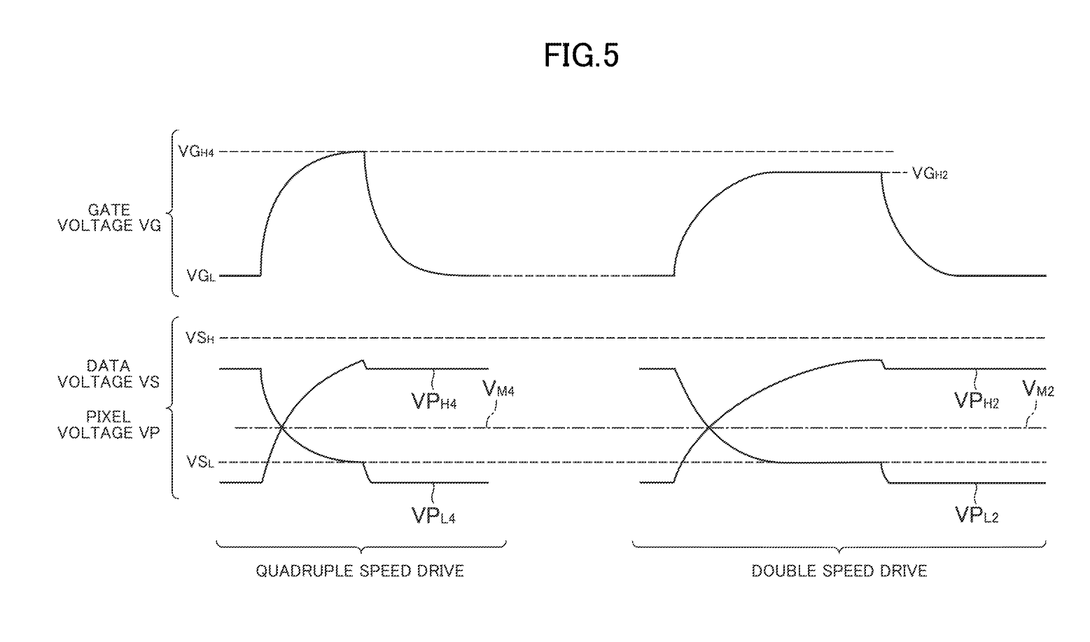

FIG. 5 is a schematic signal waveform diagram illustrating writing of the video signal to the pixel electrode in one certain row in the quadruple speed drive and the double speed drive, and represents the time variation of the gate voltage VG, the data voltage VS, and the pixel voltage VP. The horizontal axis represents time, and the vertical axis represents voltage. The signal waveforms in the quadruple speed drive represented in the left half of FIG. 5 are the same as those in the quadruple speed drive represented in the left half of each of FIG. 9 and FIG. 3.

On the other hand, in the double speed drive illustrated in the right half of FIG. 5, the pulse height of the gate voltage VG is set lower than that in the quadruple speed drive. As already described above, the change speed of the pixel voltage VP at the time of data voltage application is different between the case where the data voltage is a positive voltage and the case where the data voltage is a negative voltage. For example, in this embodiment of the case of an n-channel TFT, the positive voltage is less written to the pixel electrode as compared to the case of the negative voltage. Therefore, when the voltage of the scanning pulse is set low in the double speed drive, the effect of suppressing writing obtained thereby is more exerted on the pixel voltage VP_{H2} than on the pixel voltage VP_{L2}, and the midpoint potential V_{M2} therebetween reduces. Therefore, through adjustment of the pulse height of the gate voltage VG, the midpoint potential V_{M2} of the pixel voltages in the double speed drive can be set equal to the midpoint potential V_{M4} of the pixel voltages in the quadruple speed drive.

Based on this principle, in the liquid crystal display device 10 of this embodiment, V_{M2} is set in advance so as to match with V_{M4}. Therefore, when the common potential V_{com} is set suitably for the quadruple speed drive, the common potential V_{com} becomes suitable also for the double speed drive, and when switching from the quadruple speed drive to the double speed drive is performed, no difference is basically generated in the DC component V_{DC} of the liquid crystal drive voltage. With this, similarly to the first embodiment, at the time of switching to the double speed drive, the brightness difference due to the difference of the DC voltage of each of the pixels, which is generated in the quadruple speed drive, is inconspicuous.

Further, the following configuration is possible. The control device 26 may provide the transition period between the period of the quadruple speed drive and the period of the double speed drive. Thus, in the transition period, the horizontal scanning period may be changed in a stepwise manner to perform the switching of the refresh rate gradually, and the voltage having a pulse height of the scanning pulse may be changed in a stepwise manner. With this configuration, it is possible to eliminate a sense of discomfort in vision due to the discontinuity of brightness, which may be caused by the difference of the refresh rate.

### Third Embodiment

A schematic configuration of a liquid crystal display device according to a third embodiment of the present invention is basically the same as the liquid crystal display device 10 of the above-mentioned embodiment illustrated in FIG. 1. In the following description, components similar to those of the first embodiment are denoted by the same reference symbols for simple description. This embodiment differs from the first embodiment in the method of realizing prevention of image quality deterioration during switching of the refresh rate. In the following, similarly to the first embodiment, description is made of the method in the case of switching from the quadruple speed drive to the double speed drive.

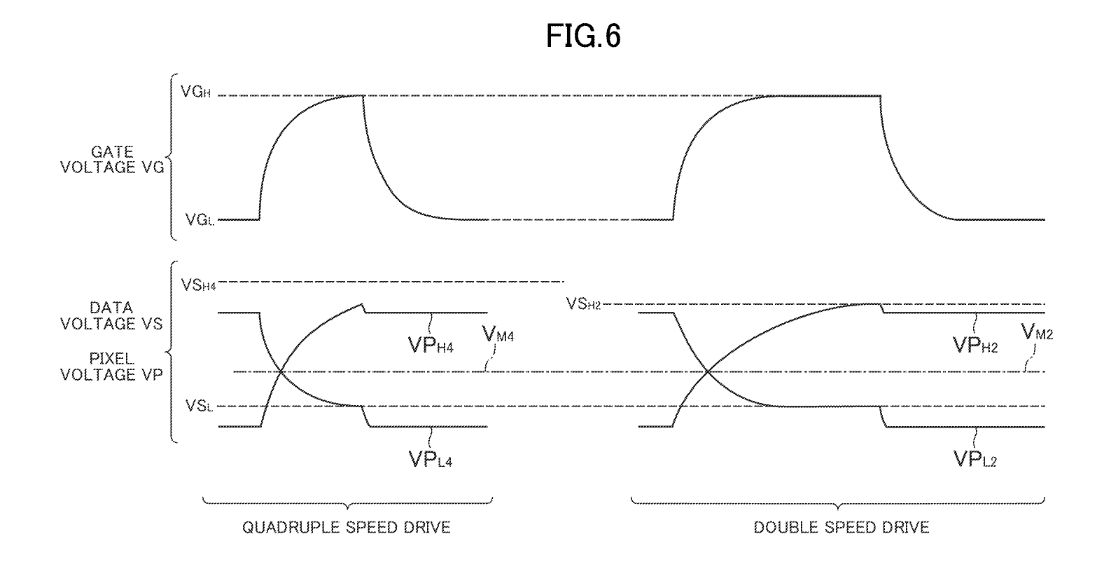

In the third embodiment, similarly to the conventional case, the width of the scanning pulse changes proportional to the horizontal scanning period. FIG. 6 is a schematic signal waveform diagram illustrating writing of the video signal to the pixel electrode in one certain row in the quadruple speed drive and the double speed drive, and represents the time variation of the gate voltage VG, the data voltage VS, and the pixel voltage VP. The horizontal axis represents time, and the vertical axis represents voltage. The signal waveforms in the quadruple speed drive represented in the left half of FIG. 6 are the same as those in the quadruple speed drive represented in the left half of each of FIG. 9, FIG. 3, and FIG. 5.

On the other hand, in the double speed drive illustrated in the right half of FIG. 6, a positive data voltage VS_{H2} is set lower than a positive voltage VS_{H4} in the quadruple speed drive. In this embodiment of the case of the n-channel TFT, as described above, a difference |VP_{H4}−VP_{H2}| with respect to certain pixel data is larger than a difference |VP_{L4}−VP_{L2}| with respect to the pixel data. In this embodiment, VS_{H2} is set lower than VS_{H4}, and thus the midpoint potential V_{M2} is reduced in the double speed drive. That is, through adjustment of the positive voltage VS_{H2} in the double speed drive, the midpoint potential V_{M2} of the pixel voltages in the double speed drive can be set equal to the midpoint potential V_{M4} of the pixel voltages in the quadruple speed drive.

Based on this principle, in the liquid crystal display device 10 of this embodiment, V_{M2} is set in advance so as to match with V_{M4}. Therefore, when the common potential V_{com} is set suitably for the quadruple speed drive, the common potential V_{com} becomes suitable also for the double speed drive, and when switching from the quadruple speed drive to the double speed drive is performed, no difference is basically generated in the DC component V_{DC} of the liquid crystal drive voltage. With this, similarly to the first embodiment, at the time of switching to the double speed drive, the brightness difference due to the difference of the DC voltage of each of the pixels, which is generated in the quadruple speed drive, is inconspicuous.

Further, the following configuration is possible. The control device 26 may provide the transition period between the period of the quadruple speed drive and the period of the double speed drive. Thus, in the transition period, the horizontal scanning period may be changed in a stepwise manner to perform the switching of the refresh rate gradually, and the positive data voltage may be changed in a stepwise manner. With this configuration, it is possible to eliminate a sense of discomfort in vision due to the discontinuity of brightness, which may be caused by the difference of the refresh rate.

In the above-mentioned embodiments, there has been described a case where switching to the double speed drive is performed in the middle of the display of the quadruple speed drive, but the present invention is applicable also to the switching between other scanning speeds.

Further, along with the increase of the refresh rate, there arises a problem in that the rounding of the rising edge of the waveform of the scanning pulse affects the writing efficiency of the pixel voltage to reduce. As a countermeasure for this problem, for example, there is conceived a drive method of advancing the rising of the scanning pulse to apply a scanning pulse having a width larger than 1H to the TFT. The present invention is applicable also to such a drive method. For example, description is made of an example in which switching from the quadruple speed drive to the double speed drive is performed when the drive method is adopted in the quadruple speed drive in which 1H is τ_{H}. In the quadruple speed drive, for example, a scanning pulse having a width of 2τ_{H} or 3τ_{H} is applied to each row by shifting the time by τ_{H}. On the other hand, in the double speed drive, a scanning pulse having a width of 2τ_{H} or 3τ_{H} is applied to each row by shifting the time by 2τ_{H}. By the way, when the width is 2τ_{H}, the double speed drive is the same as the general drive method.

As described above, according to the present invention, it becomes possible to prevent image quality deterioration in the liquid crystal display device caused by a type of screen burn-in phenomenon which occurs when the refresh rate is switched.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device, comprising:
a liquid crystal panel of an active matrix drive type, comprising:
a switching element which establishes electrical connection through application of a gate pulse from a scanning line;
a pixel electrode to be supplied with a pixel voltage corresponding to a pixel value from a video line via the switching element; and
a common electrode for generating, together with the pixel electrode, an electric field for driving liquid crystal; and
a drive circuit for driving the liquid crystal panel in an inversion drive method, the drive circuit being capable of switching between a first display operation and a second display operation which have horizontal scanning periods that differ from each other,
the drive circuit comprising:
a common electrode drive circuit for applying a common voltage, which is set in advance based on a midpoint potential in inversion drive of voltages set for the pixel electrode in the first display operation, to the common electrode in the first display operation and the second display operation; and
a scanning line drive circuit for generating the gate pulse in common for the first display operation and the second display operation.

2. The liquid crystal display device according to claim 1, wherein the drive circuit is configured to provide a transition period between a period of the first display operation and a period of the second display operation, for changing the horizontal scanning period in a stepwise manner.

3. The liquid crystal display device according to claim 1,
wherein the second display operation has a refresh rate that is half of a refresh rate of the first display operation, and
wherein the scanning line drive circuit is configured to generate the gate pulse having a width corresponding to the horizontal scanning period in the first display operation.

4. The liquid crystal display device according to claim 2,
wherein the second display operation has a refresh rate that is half of a refresh rate of the first display operation, and
wherein the scanning line drive circuit is configured to generate the gate pulse having a width corresponding to the horizontal scanning period in the first display operation.

5. A liquid crystal display device, comprising:
a liquid crystal panel of an active matrix drive type, comprising:
a switching element which establishes electrical connection through application of a gate pulse from a scanning line;
a pixel electrode to be supplied with a pixel voltage corresponding to a pixel value from a video line via the switching element; and
a common electrode for generating, together with the pixel electrode, an electric field for driving liquid crystal; and
a drive circuit for driving the liquid crystal panel in an inversion drive method, the drive circuit being capable of switching between a first display operation and a second display operation which have horizontal scanning periods that differ from each other,
the drive circuit comprising:
a common electrode drive circuit for applying a common voltage, which is set in advance based on a midpoint potential in inversion drive of voltages set for the pixel electrode in the first display operation, to the common electrode in the first display operation and the second display operation; and
a scanning line drive circuit for changing a width of the gate pulse proportional to the horizontal scanning period when switching is performed between the first display operation and the second display operation, and setting, in the second display operation, a voltage of the gate pulse to a value determined in advance so that a midpoint potential in the inversion drive of voltages set for the pixel electrode in the second display operation matches with the common voltage.

6. The liquid crystal display device according to claim 5, wherein the drive circuit is configured to:
provide a transition period between a period of the first display operation and a period of the second display operation, for changing the horizontal scanning period in a stepwise manner; and
change the voltage of the gate pulse in the stepwise manner in the transition period.

7. The liquid crystal display device according to claim 5,
wherein the switching element comprises an n-type thin film transistor,
wherein the second display operation has a refresh rate that is half of a refresh rate in the first display operation, and
wherein the scanning line drive circuit is configured to set the voltage of the gate pulse in the second display operation to be lower than a voltage of the gate pulse in the first display operation.

8. The liquid crystal display device according to claim 6,
wherein the switching element comprises an n-type thin film transistor,
wherein the second display operation has a refresh rate that is half of a refresh rate in the first display operation, and
wherein the scanning line drive circuit is configured to set the voltage of the gate pulse in the second display operation to be lower than a voltage of the gate pulse in the first display operation.

9. A liquid crystal display device, comprising:
a liquid crystal panel of an active matrix drive type, comprising:
a switching element which establishes electrical connection through application of a gate pulse from a scanning line;
a pixel electrode to be supplied with a pixel voltage corresponding to a pixel value from a video line via the switching element; and
a common electrode for generating, together with the pixel electrode, an electric field for driving liquid crystal; and
a drive circuit for driving the liquid crystal panel in an inversion drive method, the drive circuit being capable of switching between a first display operation and a second display operation which have horizontal scanning periods that differ from each other,
the drive circuit comprising:
a common electrode drive circuit for applying a common voltage, which is set in advance based on a midpoint potential in inversion drive of voltages set for the pixel electrode in the first display operation, to the common electrode in the first display operation and the second display operation; and
a scanning line drive circuit for changing a width of the gate pulse proportional to the horizontal scanning period when switching is performed between the first display operation and the second display operation, and setting, in the second display operation, the pixel voltage with respect to each pixel value to a value obtained by multiplying the pixel voltage in the first display operation with respect to the corresponding pixel value by a factor determined in advance so that a midpoint potential in the inversion drive in the second display operation matches with the common voltage.

10. The liquid crystal display device according to claim 9, wherein the drive circuit is configured to:
provide a transition period between a period of the first display operation and a period of the second display operation, for changing the horizontal scanning period in a stepwise manner; and
change the factor in the stepwise manner in the transition period.

11. The liquid crystal display device according to claim 9,
wherein the switching element comprises an n-type thin film transistor,
wherein the second display operation has a refresh rate that is half of a refresh rate in the first display operation, and
wherein the scanning line drive circuit is configured to set the factor to be smaller than 1.

12. The liquid crystal display device according to claim 10,
wherein the switching element comprises an n-type thin film transistor,
wherein the second display operation has a refresh rate that is half of a refresh rate in the first display operation, and
wherein the scanning line drive circuit is configured to set the factor to be smaller than 1.
